(19) United States
(12) Patent Application Publication
(10) Pub. No.: US 2022/0413915 A1
(43) Pub. Date: Dec. 29, 2022

(54) FLEXIBLE CLUSTER FORMATION AND WORKLOAD SCHEDULING

(71) Applicant: Intel Corporation, Santa Clara, CA (US)

(72) Inventors: Raju Arvind, Bangalore (IN); Anil Keshavamurthy, Portland, OR (US); Greeshma Pisharody, Portland, OR (US); Masoud Sajadieh, Fremont, CA (US); Mukund Shenoy, Chandler, AZ (US); Ranganath Sunku, Beaverton, OR (US)

(21) Appl. No.: 17/929,577

(22) Filed: Sep. 2, 2022

(51) Int. Cl. G06F 9/50

(52) U.S. Cl. CPC G06F 9/505; G06F 9/5072; G06F 2209/505; G06F 2209/508

(57) ABSTRACT

Techniques are disclosed for the cell/cluster formation of compute nodes and workload and processing resource scheduling. Compute nodes within an environment may be grouped (clustered) together to perform one or more designated workload tasks. The clustered compute nodes may be associated with (or assigned to) a workload cell formed to perform one or more identified task(s).

### TECHNICAL FIELD

The disclosure generally relates to workload management, including adaptable cell/cluster formation of computing resources and processing resource scheduling.

### BACKGROUND

Environments may include distributed edge computing and which use autonomous agents to perform tasks within the environments. Conventional techniques use computing resources that are allocated in a fixed deployment without the ability to adapt and redistribute the workloads among other computing resources. Such techniques also lack the ability to form and manage workload cells or clusters that may be adapted based on environmental conditions.

### BRIEF DESCRIPTION OF THE DRAWINGS/FIGURES

The accompanying drawings, which are incorporated herein and form a part of the specification, illustrate the present disclosure and, together with the description, and further serve to explain the principles of the disclosure and to enable a person skilled in the pertinent art to make and use the techniques discussed herein.

FIG. 1 illustrates a block diagram of an exemplary compute node environment, in accordance with the disclosure.

FIG. 2 illustrates a block diagram of an exemplary autonomous agent in accordance with the disclosure.

FIG. 3 illustrates a block diagram of an exemplary computing device in accordance with the disclosure.

FIG. 4 illustrates an exemplary system in accordance with the disclosure.

FIG. 5 illustrates an exemplary system in accordance with the disclosure.

FIG. 6 illustrates an exemplary system in accordance with the disclosure.

FIGS. 7A-7B illustrate an operational flowchart of a cluster formation method in accordance with the disclosure.

The present disclosure will be described with reference to the accompanying drawings. The drawing in which an element first appears is typically indicated by the leftmost digit(s) in the corresponding reference number.

### DETAILED DESCRIPTION

The following detailed description refers to the accompanying drawings that show, by way of illustration, exemplary details in which the disclosure may be practiced. In the following description, numerous specific details are set forth in order to provide a thorough understanding of the present disclosure. However, it will be apparent to those skilled in the art that the various designs, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring the disclosure.

The present disclosure provides an advantageous solution for cluster formation of compute nodes and workload and processing resource scheduling. Compute nodes within an environment may be grouped (clustered) together to perform one or more designated workload tasks. The clustered compute nodes may be associated with (or assigned to) a workload cell formed to perform one or more identified task(s). The processing required to perform the identified task(s) may be distributed amongst the compute node(s) within the workload cell, compute nodes at the edge of the workload cell, and/or one or more network devices, such as one or more access points, gateways, Edge devices, and/or servers supporting the environment. The environment may include various computing devices, which may include autonomous agents, such as Autonomous Mobile Robots (AMRs), Autonomous Guided Vehicles (AGVs), and/or stationary robots, network components and/or other networking infrastructure, sensors, and/or other computing devices. These components may generally be referred to as compute nodes because such components/devices are configured to perform data processing and/or the control of one or more other devices.

These components are increasing being adapted for use in factories, warehouses, hospitals, and other industrial and/or commercial environments. Autonomous mobile platforms implement perception and manipulation jointly to accomplish a given task by navigating an environment. Autonomous agents may use motion and path planning to navigate the environment that may be a partial or fully autonomous environment, or one that is generally free of autonomous agents (non-autonomous environments). The system may be configured to implement a centralized algorithm that generates collision-free trajectories for multiple cooperating AMRs in a shared, dynamic environment. Collision-free trajectories are generated, considering the obstacles detected by the AMR's sensors, the neighboring AMR's sensors, obstacles detected by one or more sensors within the environment, as well as the trajectories of neighboring AMRs themselves.

The disclosure is described with reference to AMRs, but the aspects are applicable to other autonomous agent as would be appreciated by those skilled in the art, including AGVs, stationary robots, autonomous vehicles, and/or other computing devices. In such environments, AMRs and/or other agents (e.g. stationary robots) may communicate and coordinating with one another and/or with a central controller (e.g. controller 108) that may be configured for management of a fleet of autonomous agents. In other configurations, the environment may include a partial or fully decentralized environment.

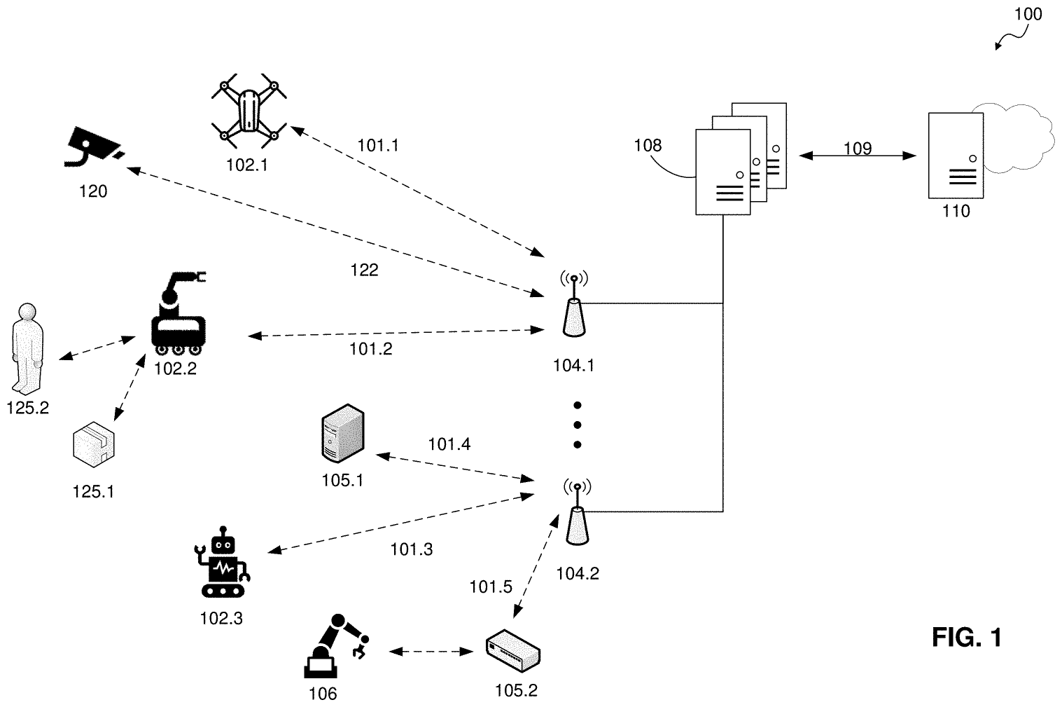

FIG. 1 illustrates an exemplary environment 100. The environment 100 may be any type of environment in which tasks requiring data processing may be performed, such as a factory, warehouse, hospital, office building, etc. Such environments 100 may use one or more autonomous agents, such as autonomous mobile robots (AMRs) 102 in accordance with the disclosure. The environment 100 supports any suitable number of AMRs 102, with three AMRs 102.1-102.3 being shown for ease of explanation. The environment 100 may also include one or more stationary robots 106 and/or one or more other computing devices 105. The AMRs 102 may have any suitable type of design and function to communicate with other components of a network infrastructure as further disused below. The AMRs 102 may operate autonomously or semi-autonomously and be configured as mobile robots that move within the environment 100 to complete specific tasks. One or more of the AMRs 102 may alternatively be configured as a stationary robot 106 having moveable components (e.g. moveable arms) to complete localized tasks.

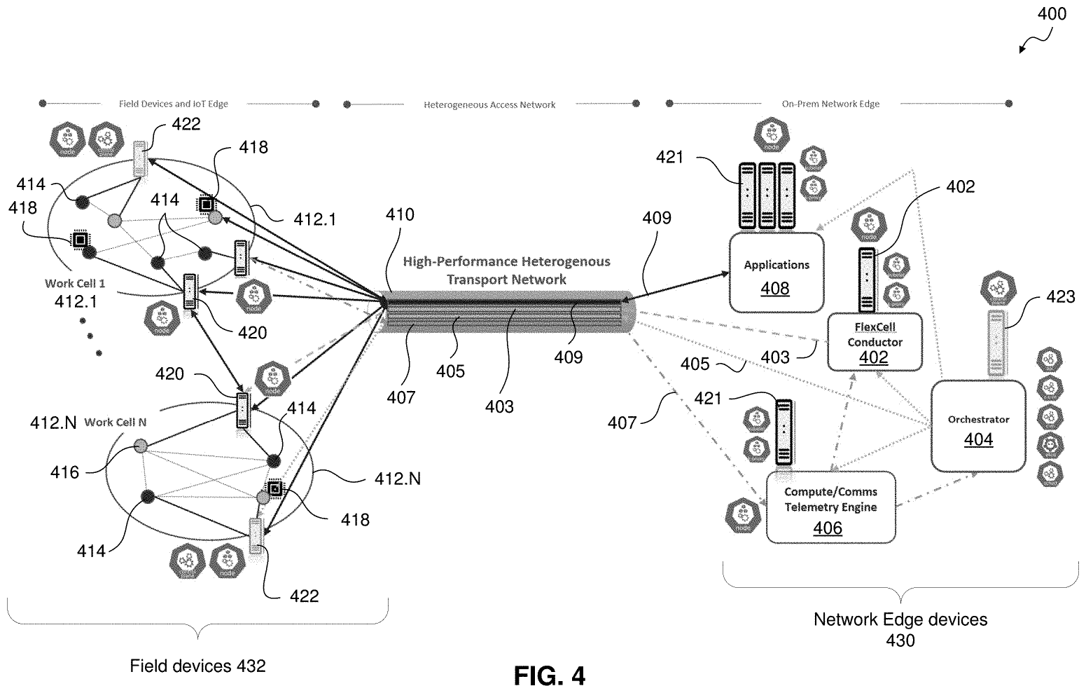

As discussed above, the Autonomous Mobile Robots (AMRs) 102, Autonomous Guided Vehicles (AGVs), stationary robots 106, network components and/or other networking infrastructure (e.g. 108, 110), sensors 120, other agents, and/or other computing devices 105 may each be generally be referred as a compute node, which is configured to perform data and/or other processing. The compute nodes may be grouped (clustered) together (as shown in FIGS. 4-6) to perform one or more designated workload tasks. The clustered compute nodes may be associated with (or assigned to) a workload cell (e.g. cell 412 in FIG. 4), which is discussed below in more detail below. The processing required to perform the identified task(s) may be distributed amongst the compute node(s) within the workload cell, compute nodes at the edge of the workload cell, and/or one or more network devices, such as one or more access points, gateways, Edge devices, and/or servers supporting the environment.

Although the disclosure includes examples of the environment 100 being a factory or warehouse that supports AMRs 102 operating within such an environment, this is by way of example and not a limitation. The teachings of the disclosure may be implemented in accordance with any suitable type of environment and/or type of mobile agent. For instance, the environment 100 may be outdoors and be identified with a region such as a roadway that is utilized by autonomous vehicles. Thus, the teachings of the disclosure are applicable to AMRs as well as other types of autonomous agents that may operate in any suitable type of environment based upon any suitable application or desired function.

As discussed previously, the environment 100 may include one or more sensors 120 configured to monitor the locations and activities of the AMRs 102, humans, machines, other robots, or other objects or devices within the environment 100. The sensors 120 may include, for example, radar (radio detection and ranging), Light detection and ranging (LIDAR), optical sensors, Red-Green-Blue-Depth (RGBD) sensors, infrared sensors, cameras, audio sensors (e.g. microphones), or other sensors as would be understood by one or ordinary skill in the art. The sensors 120 may communicate information (sensor data) with the computing device 108 (via access point(s) 104). Although not shown in FIG. 1 for purposes of brevity, the sensor(s) 120 may additionally communicate with one another, with computing device(s) 105, and/or with one or more of the AMRs 102.

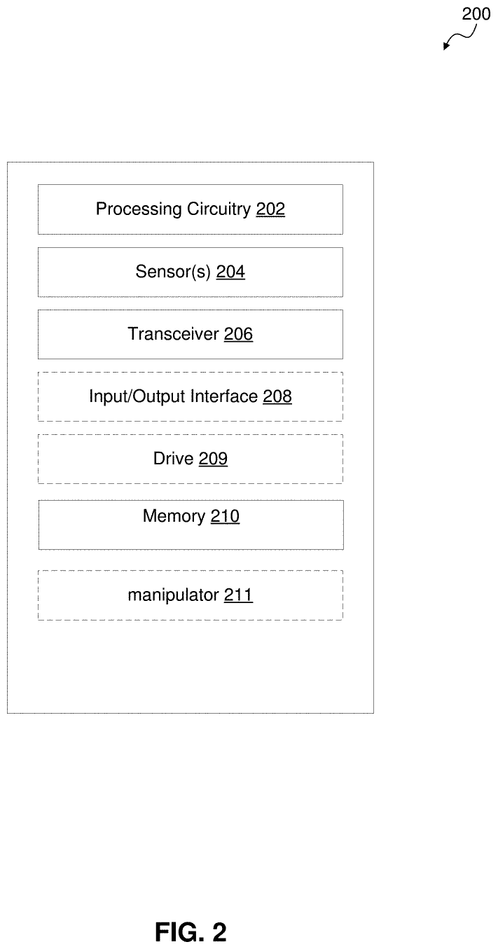

With reference to FIG. 2, an autonomous agent 200 according to the disclosure are shown. The autonomous agent 200 may include the implementations of the agents 102 shown in FIG. 1, including AMRs, AGVs, stationary robots, or other agents. For ease of discussion, the autonomous agent 200 is discussed with reference to AMRs, but the aspects discussed are applicable to other autonomous agents including AGVs, stationary robots, autonomous vehicles, and/or other computing devices.

The agents (AMRs) 102 may implement a suite of onboard sensors 204 to generate sensor data indicative of the location, position, velocity, heading orientation, etc. of the agent 102. These sensors 204 may be implemented as any suitable number and/or type that are generally known and/or used for autonomous navigation and environmental monitoring. Examples of such sensors may include radar; LIDAR; optical sensors, such as Red-Green-Blue-Depth (RGBD) sensors; cameras; audio sensors (e.g. microphones), compasses; gyroscopes; positioning systems for localization; accelerometers; etc. Thus, the sensor data may indicate the presence of and/or range to various objects near each AMR 102. Each AMR 102 may additionally process this sensor data to identify obstacles or other relevant information within the environment 100. The AMR 102 may offload the processing of sensor and/or other data to one or more other computing devices within the environment 100 and/or in communication with the environment 100. For example, the AMR 102 may offload the processing of sensor and/or other data to the central controller 108 and/or to one or more other neighboring AMRs 102.

The AMRs 102 may use the sensor data to calculate (e.g. iteratively) respective navigation paths. The AMRs 102 may also have any suitable number and/or type of hardware and/or software configurations to facilitate autonomous navigation functions within the environment 100, including known configurations. For example, each AMR 102 may implement a controller that may comprise one or more processors or processing circuitry 202, which may execute software that is installed on a local memory 210 to perform various autonomous navigation-related functions.

The AMR 102 may use onboard sensors 204 to perform pose estimation and/or to identify e.g. a position, orientation, velocity, direction, and/or location of the AMR 102 within the environment 100 as the AMR 102 moves along a particular planned path. The processing circuitry 202 can execute a path planning algorithm stored in memory 210 to execute path planning and sampling functionalities for navigation-related functions (e.g. SLAM, octomap generation, multi-robot path planning, etc.) of the AMR 102.

The AMRs 102 may further be configured with any suitable number and/or type of wireless radio components to facilitate the transmission and/or reception of data. For example, the AMRs 102 may transmit data indicative of current tasks being executed, location, orientation, velocity, trajectory, heading, etc. within the environment 100 (via transceiver 206 as shown in FIG. 2). As another example, the AMRs 102 may receive commands and/or planned path information from the computing device 108, which each AMR 102 may execute to navigate to a specific location within the environment 100. Although not shown in FIG. 1 for purposes of brevity, the AMRs 102 may additionally communicate with one another to determine information (e.g. current tasks being executed, location, orientation, velocity, trajectory, heading, etc.) with respect to the other AMRs 102, as well as other information such as sensor data generated by other AMRs 102.

The AMRs 102 operate within the environment 100 by communicating with the various components of the supporting network infrastructure and/or communicating with one or more other AMRs 102. The network infrastructure may include any suitable number and/or type of components to support communications with the AMRs 102. For example, the network infrastructure may include any suitable combination of wired and/or wireless networking components that operate in accordance with any suitable number and/or type of communication protocols. For instance, the network infrastructure may include interconnections using wired links such as Ethernet or optical links, as well as wireless links such as Wi-Fi (e.g. 802.11 protocols) and cellular links (e.g. 3GPP standard protocols, LTE, 5G, etc.). The network infrastructure may be, for example, an access network, an edge network, a mobile edge computing (MEC) network, etc. In the example shown in FIG. 1, the network infrastructure includes one or more cloud servers 110 that enable a connection to the Internet, which may be implemented as any suitable number and/or type of cloud computing devices. The network infrastructure may additionally include a computing device 108, which may be implemented as any suitable number and/or type of computing device such as a server. The computing device 108 may be implemented as an Edge server and/or Edge computing device, but is not limited thereto. The computing device 108 and/or server 110 may also be referred to as a controller.

According to the disclosure, the computing device 108 may communicate with the one or more cloud servers 110 via one or more links 109, which may represent an aggregation of any suitable number and/or type of wired and/or wireless links as well as other network infrastructure components that are not shown in FIG. 1 for purposes of brevity. For instance, the link 109 may represent additional cellular network towers (e.g. one or more base stations, eNodeBs, relays, macrocells, femtocells, etc.). According to the disclosure, the network infrastructure may further include one or more access points (APs) 104. The APs 104 may be implemented in accordance with any suitable number and/or type of APs configured to facilitate communications in accordance with any suitable type of communication protocols. The APs 104 may be configured to support communications in accordance with any suitable number and/or type of communication protocols, such as an Institute of Electrical and Electronics Engineers (IEEE) 802.11 Working Group Standards. Additionally, or alternatively, the APs 104 may operate in accordance with other types of communication standards other than the 802.11 Working Group, such as cellular based standards (e.g. “private cellular networks) or other local wireless network systems, for instance. Additionally, or alternatively, the AMRs 102 may communicate directly with the computing device 108 or other suitable components of the network infrastructure without the need to use the APs 104. Additionally, or alternatively, one or more of AMRs 102 may communicate directly with one or more other AMRs 102.

Communications between AMRs 102 and/or other computing devices 105 may be directed to one or more individual devices and/or broadcast to multiple AMRs 102 and/or devices 105. Communications may be relayed by or more network components (e.g. access points) and/or via one or more other intermediate AMRs 102 and/or devices 105. Similarly, communications between the computing device 108 and/or servers 110 and one or more AMR(s) 102 and/or devices 105 may be directed to one or more individual AMRs and/or devices, and/or broadcast to multiple AMRs 102 and/or devices 105. Communications may be relayed by or more network components (e.g. access points) and/or via one or more other intermediate AMRs 102 and/or devices 105.

In the environment 100 as shown in FIG. 1, the computing device 108 is configured to communicate with one or more of devices within the environment 100, such as the AMRs 102, sensors 120, and/or computing devices 105, to receive data from the device(s) and to transmit data to the device(s). This functionality may be additionally or alternatively be performed by other network infrastructure components that are capable of communicating directly or indirectly with the devices, such as the one or more cloud servers 110, for instance. However, the local nature of the computing device 108 may provide additional advantages in that the communication between the computing device 108 and the deployed devices within the environment 100 may occur with reduced network latency. Thus, according to the disclosure, the computing device 108 is used as the primary example when describing this functionality, although it is understood that this is by way of example and not limitation. The one or more cloud servers 110 may function as a redundant system for the computing device 108.

The computing device 108 may thus receive data (e.g. sensor data) from the devices (e.g. AMRs 102) via the APs 104 and use the respective data, together with other information about the environment 100 that is already known (e.g. data regarding the size and location of static objects 125 in the environment 100, last known locations of dynamic objects, etc.), to generate a shared environment model that represents the environment 100

### AMR Design and Configuration

Turning back to FIG. 2, a block diagram of an exemplary autonomous agent 200 in accordance with the disclosure is illustrated. The autonomous agent 200 as shown and described with respect to FIG. 2 may be identified with one or more of the AMRs 102 or other autonomous agents as shown in FIG. 1 and discussed herein. The autonomous agent 200 may include processing circuitry 202, one or more sensors 204, a communication interface (transceiver) 206, and a memory 210. The autonomous agent 200 may additionally include input/output (I/O) interface 208, drive 209 (e.g. when the agent 200 is a mobile agent), and/or manipulator 211. The components shown in FIG. 2 are provided for ease of explanation, and the autonomous agent 200 may implement additional, less, or alternative components as those shown in FIG. 2.

The processing circuitry 202 may be configured as any suitable number and/or type of computer processors, which may function to control the autonomous agent 200 and/or other components of the autonomous agent 200. The processing circuitry 202 may be identified with one or more processors (or suitable portions thereof) implemented by the autonomous agent 200. The processing circuitry 202 may be configured to carry out instructions to perform arithmetical, logical, and/or input/output (I/O) operations, and/or to control the operation of one or more components of autonomous agent 200 to perform various functions associated with the disclosure as described herein. For example, the processing circuitry 202 may include one or more microprocessor cores, memory registers, buffers, clocks, etc., and may generate electronic control signals associated with the components of the autonomous agent 200 to control and/or modify the operation of these components. For example, the processing circuitry 202 may control functions associated with the sensors 204, the transceiver 206, interface 208, drive 209, memory 210, and/or manipulator 211. The processing circuitry 202 may additionally perform various operations to control the movement, speed, and/or tasks executed by the autonomous agent 200, which may be based upon global and/or local path planning algorithms, as discussed herein.

The sensors 204 may be implemented as any suitable number and/or type of sensors that may be used for autonomous navigation and environmental monitoring. Examples of such sensors may include radar, LIDAR, optical sensors, Red-Green-Blue-Depth (RGBD) sensors, cameras, audio sensors, compasses, gyroscopes, positioning systems for localization, accelerometers, audio sensors, etc.

The transceiver 206 may be implemented as any suitable number and/or type of components configured to transmit and/or receive data packets and/or wireless signals in accordance with any suitable number and/or type of communication protocols. The transceiver 206 may include any suitable type of components to facilitate this functionality, including components associated with known transceiver, transmitter, and/or receiver operation, configurations, and implementations. Although depicted in FIG. 2 as a transceiver, the transceiver 206 may include any suitable number of transmitters, receivers, or combinations of these that may be integrated into a single transceiver or as multiple transceivers or transceiver modules. For example, the transceiver 206 may include components typically identified with an RF front end and include, for example, antennas, ports, power amplifiers (PAs), RF filters, mixers, local oscillators (LOs), low noise amplifiers (LNAs), upconverters, downconverters, channel tuners, etc. The transceiver 206 may also include analog-to-digital converters (ADCs), digital to analog converters, intermediate frequency (IF) amplifiers and/or filters, modulators, demodulators, baseband processors, and/or other communication circuitry as would be understood by one of ordinary skill in the art.

I/O interface 208 may be implemented as any suitable number and/or type of components configured to communicate with a human operator. The I/O interface 208 may include microphone(s), speaker(s), display(s), image projector(s), light(s), laser(s), and/or other interfaces as would be understood by one of ordinary skill in the arts.

The drive 209 may be implemented as any suitable number and/or type of components configured to drive the autonomous agent 200, such as a motor or other driving mechanism. The processing circuitry 202 may be configured to control the drive 209 to move the autonomous agent 200 in a desired direction and at a desired velocity.

The memory 210 stores data and/or instructions such that, when the instructions are executed by the processing circuitry 202, cause the autonomous agent 200 to perform various functions as described herein. The memory 210 may be implemented as any well-known volatile and/or non-volatile memory. The memory 210 may be implemented as a non-transitory computer readable medium storing one or more executable instructions such as, for example, logic, algorithms, code, etc. The instructions, logic, code, etc., stored in the memory 210 may enable the features disclosed herein to be functionally realized. For hardware implementations, the modules shown in FIG. 2 associated with the memory 210 may include instructions and/or code to facilitate control and/or monitor the operation of such hardware components.

The manipulator 211 may be implemented as any suitable number and/or type of components configured to interact with and/or manipulate the environment and/or object(s) 125 within the environment, such as a manipulator arm, claw, gripper, or other mechanism to interact with one or more objects 125.

### Computing Device Design and Configuration

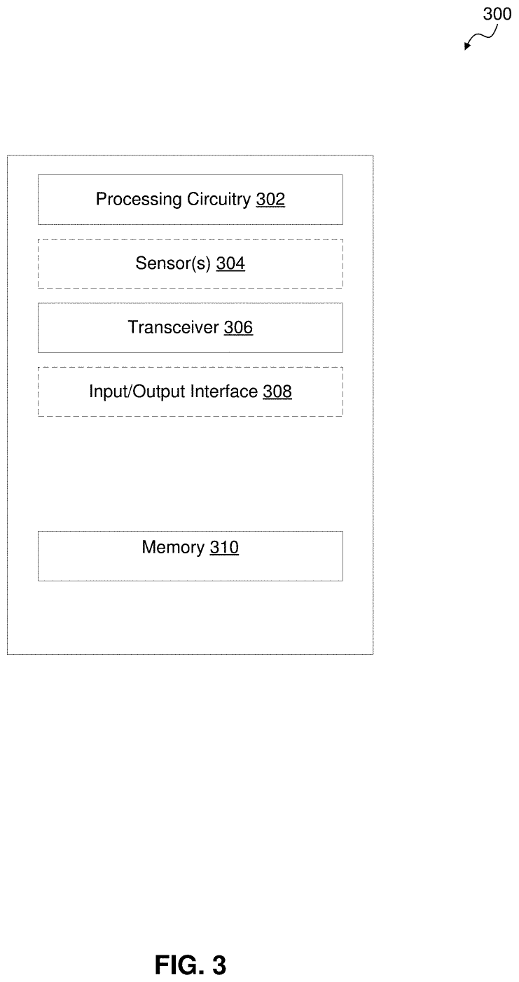

FIG. 3 illustrates a block diagram of an exemplary computing device 300, in accordance with the disclosure. The computing device 300 that may be used with one or more of the computational systems is described with reference to FIG. 3. For example, the computing device 300 as shown and described with respect to FIG. 3 may be identified with the computing device(s) 105, computing device(s) 108, and/or server(s) 110 as shown in FIG. 1 and discussed herein. The computing device 300 may be implemented as an Edge server and/or Edge computing device, such as when identified with the computing device 108 implemented as an Edge computing device, as a cloud-based computing device when identified with the server 110 implemented as a cloud server, and/or as a computing device 105 when identified with device(s) 105 within the environment 100, such as when identified as a compute node within and/or at the edge of a workload cell 412.

The computing device 300 may include processing circuitry 302, a transceiver 306, and a memory 310. The computing device may also include one or more sensors 304 and/or an Input/Output (I/O) Interface 308.

In some examples, the computer device 300 is configured to interact with one or more external sensors (e.g. sensor 120) as an alternative or in addition to including internal sensors 304. The components shown in FIG. 3 are provided for ease of explanation, and the computing device 300 may implement additional, less, or alternative components as those shown in FIG. 3.

The processing circuitry 302 may be configured as any suitable number and/or type of computer processors, which may function to control the computing device 300 and/or other components of the computing device 300. The processing circuitry 302 may be identified with one or more processors (or suitable portions thereof) implemented by the computing device 300.

The processing circuitry 302 may be configured to carry out instructions to perform arithmetical, logical, and/or input/output (I/O) operations, and/or to control the operation of one or more components of computing device 300 to perform various functions as described herein. For example, the processing circuitry 302 may include one or more microprocessor cores, memory registers, buffers, clocks, etc., and may generate electronic control signals associated with the components of the computing device 300 to control and/or modify the operation of these components. For example, the processing circuitry 302 may control functions associated with the sensors 304, the transceiver 306, interface 308, and/or the memory 310.

According to the disclosure, the processing circuitry 302 may be configured to: process data or information, such as data/information about the environment 100, data received from one or more sensors 120, data received from one or more other components (e.g. AMRs 102, robots 106, devices 108, devices 109), data received from other computing devices 105, data received from AP(s) 104, or the like.

The sensors 304 may be implemented as any suitable number and/or type of sensors. Examples of such sensors may include radar, LIDAR, optical sensors, Red-Green-Blue-Depth (RGBD) sensors, cameras, audio sensors, compasses, gyroscopes, positioning systems for localization, accelerometers, etc. In some examples, the computing device 300 is additionally or alternatively configured to communicate with one or more external sensors similar to sensors 304 (e.g. sensor 120 in FIG. 1).

The transceiver (communication interface) 306 may be implemented as any suitable number and/or type of components configured to transmit and/or receive data packets and/or wireless signals in accordance with any suitable number and/or type of communication protocols. The transceiver 306 may include any suitable type of components to facilitate this functionality, including components associated with known transceiver, transmitter, and/or receiver operation, configurations, and implementations. Although depicted in FIG. 3 as a transceiver, the transceiver 306 may include any suitable number of transmitters, receivers, or combinations of these that may be integrated into a single transceiver or as multiple transceivers or transceiver modules. For example, the transceiver 306 may include components typically identified with an RF front end and include, for example, antennas, ports, power amplifiers (PAs), RF filters, mixers, local oscillators (LOs), low noise amplifiers (LNAs), upconverters, downconverters, channel tuners, etc. The transceiver 306 may also include analog-to-digital converters (ADCs), digital to analog converters, intermediate frequency (IF) amplifiers and/or filters, modulators, demodulators, baseband processors, and/or other communication circuitry as would be understood by one of ordinary skill in the art.

I/O interface 308 may be implemented as any suitable number and/or type of components configured to communicate with a human operator. The I/O interface 308 may include microphone(s), speaker(s), display(s), image projector(s), light(s), laser(s), and/or other interfaces as would be understood by one of ordinary skill in the arts.

The memory 310 stores data and/or instructions such that, when the instructions are executed by the processing circuitry 302, cause the computing device 300 to perform various functions as described herein. The memory 310 may be implemented as any well-known volatile and/or non-volatile memory. The memory 310 may store software used by the computing device 300, such as an operating system, application programs, and/or an associated internal database.

The memory 310 may be implemented as a non-transitory computer readable medium storing one or more executable instructions such as, for example, logic, algorithms, code, etc. The instructions, logic, code, etc., stored in the memory 310 are may be represented by various modules which may enable the features described herein to be functionally realized. For example, the memory 310 may include one or more modules representing an algorithm. For hardware implementations, the modules associated with the memory 310 may include instructions and/or code to facilitate control and/or monitor the operation of such hardware components. Thus, the disclosure includes the processing circuitry 302 executing the instructions stored in the memory in conjunction with one or more hardware components to perform the various functions described herein.

Although various components of computing device 300 are described separately, functionality of the various components may be combined and/or performed by a single component and/or multiple computing devices in communication without departing from the disclosure.

Turning to FIG. 4, a system 400 for flexible cluster formation and workload scheduling is shown. The system 400 is configured to manage tasks and processing workloads of components within an environment 100, and to cluster compute nodes (e.g. nodes 416, 418, 420, 422) to form a corresponding work cell 412 designated to complete a desired task.

Compute nodes within the environment may be grouped (clustered) together to perform one or more designated workload tasks. The clustered compute nodes may be associated with (or assigned to) a workload cell 412 formed to perform one or more identified task(s). The processing required to perform the identified task(s) may be distributed amongst the compute node(s) (e.g. 414, 416, 418) within the workload cell 412, compute nodes at the edge (e.g. 420, 422) of the workload cell 412, and/or one or more network devices, such as one or more access points 104, gateways, Edge devices 108, and/or servers 110 supporting the environment 100. The compute nodes distributed within the environment 100 may be collectively referred to as field devices 432.

The compute nodes may include: general nodes 414, such as sensors or other low-computing endpoints; mobile compute nodes 416, such as autonomous agents (e.g. AMRs); smart compute nodes 418, such as gateways, control nodes, or advanced sensors; workload edge nodes 420; and workload edge control nodes 422. According to the disclosure, the smart compute nodes 418 may also be mobile nodes (indicated by the orange colored dot) or non-mobile (as indicated by the black dot).

The mobile compute nodes 416 and the smart compute nodes 418 may have more extensive processing capabilities as compared to the general nodes 414. The workload edge nodes 420 and the workload edge control nodes 422 may have more processing capabilities than the nodes 416, 418, and 420. Additionally, the workload edge control nodes 422 may further be configured to perform workload cell-level orchestration and/or have more processing capability that the workload edge nodes 420. In this example, the workload edge control nodes 422 may provide orchestration at the cell-level while the orchestrator 404 provides network-level orchestration.

The system 400 may include a FlexCell conductor (FC) 402, an Orchestrator 404, a compute/communication Telemetry engine 406, and one or more applications 408. The devices 402, 404, 406, and 408 may be embodied on separate computing devices (e.g. device 300), or two or more devices may be embodied on the same device. Additionally, or alternatively, a device 402, 404, 406, 408 may be distributed across two or more computing devices 300.

The FC 402, Orchestrator 404, Telemetry engine 406, and application(s) 408 may be located at the network edge and in communication with the compute nodes within the environment via a heterogenous transport network 410. The FC 402, Orchestrator 404, Telemetry engine 406, and application(s) 408 may collectively be referred to as network edge components 430. The applications 408 may include one or more applications that may run on one or more of the field devices 432 (compute nodes). The applications may be assigned to one or more compute nodes based on the specified task of the compute node. The applications may be stored on respective compute node(s), at the network edge, distributed between the network edge and the compute node(s), and/or between several compute nodes. According to the disclosure, the FC 402, Orchestrator 404, and/or the telemetry engine 406 may use machine learning adapt the corresponding operations of the respective device.

The network 410 may support any suitable number and/or type of communication protocols, and may include interconnections using wired links such as Ethernet or optical links, as well as wireless links such as Wi-Fi (e.g. 802.11 protocols) and cellular links (e.g. 3GPP standard protocols, LTE, 5G, etc.). The network 410 may be configured to facilitate the communication of telemetry data 407, orchestration data 405, control data 403, user data 409, and other data and information as would be understood by one of ordinary skill in the art.

The system 400 according to the disclosure is configured to map a use-case into a composite list of compute nodes with defined node attributes. Each compute node may be recruited/assigned to a workload cell 412 for the duration of the use case (job). In some aspects, the node(s) may be decommissioned (unassigned) from the workload cell 412 and/or redeployed to another workload cell 412. For example, upon completion of the use case, the compute node(s) 432 may be returned for re-deployment in another flexible manufacturing workload cell 412. The workload cells 412 are managed by the FC 402 and at any point in time, two or more workload cells 412 may concurrently exist. The lifecycle of the cell 412 is managed by the FC 402, which may be located at the network edge. In other aspects, one or more of the network edge devices 430 may be embodied at another location in the network infrastructure, such as in a remote server (e.g. server 110).

According to the disclosure, the FC 402 may be configured to determine a target configuration for one or more identified tasks and the necessary compute nodes to complete the task(s). The target configuration may include the task(s) for a particular use case as well as parameters for the use case, which may include quality of service (QoS) requirements, telemetry metrics, software metrics, hardware metrics, network metrics, or other parameters and/or thresholds that define the use case. The FC 402 may determine the target configuration based on production specifications (e.g. received from one or more enterprise system).

The FC 402 may determine the required compute node(s) for the use case and generate a node manifest (template) based on the determined node(s). The FC 402 may generate the node manifest that describes what types and quantity of compute nodes are needed for a requested task/workload. The FC 402 may translate received external instructions (e.g. production specifications) to determine the types and quantity of compute nodes and workloads. For example, the FC 402 identifies the particular quantity and types of nodes for the current use case (job) and that are to be allocated for a particular workload cell 412. The FC 402 may determine the types of node based on the necessary node attributes for the use case.

According to the disclosure, the FC 402 may be unaware of the actual available compute nodes within the environment 100. In this aspect, the FC 402 may leverage orchestration information from the orchestrator 404 to determine and manage the workload cell 412 and the deployed compute nodes therein. The orchestration information may include the available compute nodes within the environment 100 and their corresponding attributes. According to the disclosure, the orchestrator 404 and the FC 402 may work together to establish the workload cells 412 and the appropriate compute nodes to be deployed to each cell. For example, the FC 402 may provide the node manifest to the orchestrator 404, which may be configured to determine the available compute nodes having the necessary attributes identified in the node manifest. The orchestrator 404 may then provide the determined available compute nodes to the FC 402 as the orchestration information to the FC 402. Using the orchestration information, the FC 402 may then establish the workload cell 412 with the available compute nodes that have the requested attributes provided in the node manifest.

The FC 402 may be configured to monitor the established workload cell 412 and adaptively add and/or remove compute nodes from the cell 412. This may include removing a compute node from one cell 412.1 and assigning the removed compute node to another cell 412.2. For example, if the compute node has finished its task within cell 412.1 or its attributes make it better suited for cell 412.2, the FC 402 may reassign the compute node to cell 412.2. In aspects where the compute node is a mobile compute node 416, the FC 402 may be configured to control the compute node 416 to physically move to the location of the newly assigned workload cell 412.2.

According to the disclosure, when adjusting the compute nodes within a cell 412, the FC 402 may adjust the node manifest to reflect the adjustments to the cell 412. The FC 402 may notify to orchestrator 414 of the updated workload cell 412 so that the orchestrator 414 is aware of the changes (e.g. if the compute node has been removed from the cell 412 and is now available for a future redeployment).

According to the disclosure, the orchestrator 404 is configured to perform computational and/or network-QoS orchestration operations. For example, the orchestrator 404 may perform computational orchestration to identify the available compute nodes and their corresponding computational capabilities. The orchestrator 404 may additionally or alternatively perform network-QoS orchestration to identify the available compute nodes and their corresponding network capabilities, network performance requirements, current network performance, and/or other network parameters. According to the disclosure, the orchestrator 404 may be configured to cooperatively perform orchestration operations with one or more workload edge control nodes 422 having an increased knowledge and visibility of the compute nodes within the respective workload cell 412. This may enhance the operation of the orchestrator 404 which may not have complete visibility of the notes within the cell 412. The cell-level orchestration may include identifying the where the computational workload is to be performed (e.g. based on latency requirements), such as by a node within the cell 412 and/or by a node at the cell edge.

According to the disclosure, the orchestrator 404 may be configured to use: (1) telemetry information (e.g. from the telemetry engine 406) and/or (2) the QoS information, network information, and/or computational information in performing the orchestration operations.

The compute/communication Telemetry (CCT) engine 406 may be configured to receive telemetry data from one or more compute nodes and to process the telemetry data to generate telemetry information. The telemetry engine 406 may then provide the telemetry information to the FC 402 and/or the Orchestrator 404. The telemetry information may be used by the FC 402 to manage the workload cells 412 and/or by the orchestrator 404 to perform orchestration operations.

In operation, the pool of available compute resources may dynamically change for applications to be assigned to the workload cells 412 and the compute nodes therein. For example, with mobile compute nodes 416 (e.g. AMRs), the movement of the compute nodes 416 may impact the wireless signal quality (e.g. QoS). With the change in the QoS, the FC 402 may adapt the workload cell 412 to modify the compute nodes within the workload cell 412.

According to the disclosure, the telemetry engine 406 may be configured to determine preferred or optimal compute nodes based on the telemetry data received by the telemetry engine 406. For example, compute nodes may compete for the shared network resources (e.g., scheduling grants and allocated physical resources), and the telemetry engine 406 may determine the preferred compute nodes for the particular workload services. Using the preferred node identified in the telemetry information, the orchestrator 404 may update the orchestration information to reflect the preferred compute node(s). The FC 402 may adjust the workloads to relocate the relocate workloads to the preferred compute nodes to best utilize available networking resources.

The criteria for determining preferred or optimal compute nodes may include one or more communication/network metrics. For example, the criteria may include a single network metric to a combination (e.g. weighted combination) of several network Key Performance Indicators (KPIs). The following framework is used to dynamically determine the best node for workload placement.

The telemetry data of each compute node may be provided to the telemetry engine 406. The telemetry engine 406 may include a Telemetry-Informed Scheduler (TIS), which may receive the telemetry data. In operation, the workload cell 412 (e.g. via the workload edge control nodes 422 of the cell) may subscribe to the TIS for a specific telemetry attribute based on the requirement(s) of the underlying application. The telemetry attributes may include, for example, End-to-End Latency, uplink throughput, downlink throughput, or other attributes as would be understood by one of ordinary skill in the art. For example, the End-to-End Latency attribute may be used for time-sensitive applications, such as the deadline for when new information is to be updated at the workload edge control nodes 422 (e.g. smooth movement of a robotic arm). In another example, the workload cell 412 may subscribe/register to the uplink throughput attribute is the associated application requires a minimum uplink bandwidth (e.g. 6 Mbps). When the bandwidth experienced at the compute node falls below the threshold, the TIS may identify another compute node, based on the telemetry data from the compute nodes, capable of meeting the throughput constraint. The orchestrator 404 may update the orchestration information based on the identified node(s), which may then be used by the FC 402 to facilitate the reallocation of the workload to the other node(s).

According to disclosure, the telemetry information may include network telemetry data and and/or compute telemetry data. The network telemetry data may include one or more Key Performance Indicators (KPIs), such as average, minimum, and peak throughput values experienced at individual UEs, statistics of the total downlink and/or uplink throughput at the network infrastructure, or other network metrics as would be understood by one of ordinary skill in the art. The network telemetry data may include real-time information about the network.

According to the disclosure, the telemetry data may be used to perform Cell Traffic aware work placement of compute nodes. For example, 5G network telemetry may be obtained (e.g. extracted) from the near real-time RAN Intelligent Controller (RIC) or any other network management system interacting with the 5G network. Through access to this network telemetry, the TIS of the CCT 406 has access to real-time information about the network Key Performance Indicators (KPIs). Using the KPIs, the system may reallocate the workloads amongst the compute nodes as discussed above.

The telemetry data may include hardware metrics, such as battery level, power level, mechanical indicators, lubrication indicators, etc.; processing architecture metrics, such as the utilization of CPU, memory, cache, power metrics, frequency, power states, TDP, power consumption, etc.; software metrics, such as operating system metrics (e.g. page faults, real time kernel metrics), orchestration agent metrics, application metrics, etc.; communication metrics, such as spectrum availability, uplink/downlink speed, Signal-to-Noise Ratio indicators, modem metrics, etc.; and/or other metrics as would be understood by one of ordinary skill in the art.

According to the disclosure, the system may be configured to correlate telemetry data and information with QoS information for the workload cells 412. The telemetry data and/or information can be used to determine preferred or optimal performance characteristics for application workloads for the compute nodes. For example, the performance of the application workloads for the compute nodes, such as video processing, analytics using machine learning (ML) or artificial intelligence (AI), data processing of sensor data, or other applications may require optimal set of processing architecture/hardware resources while ensuring that the applications running on the compute node(s) meet minimal operational conditions (e.g. battery level, mechanical indicators, etc.) to comply with the service-level agreement (SLA).

The network edge devices 430 may be configured to correlate telemetry data and/or information from compute nodes (e.g. hardware, software, and/or processing architecture metrics) and the network metrics to facilitate workload placement amongst the compute nodes and workload cells 412, the scaling policies, and/or de-scheduling policies to ensure the QoS is satisfied. For example, the network hardware (e.g. 5G user plane function (UPF)) may provide an analytics application on the infrastructure Edge. The analytics application may update the orchestrator 404 with a set of scheduling policies to schedule/de-schedule/distribute the application workloads on the compute nodes within a workload cell 412.

This methodology could be scaled across workload cells/clusters by correlating live telemetry with QoS policies across the cells/clusters there by distributing workloads across as necessary.

Example scenarios in which the inventive system advantageously facilitates workload and workload cell management are discussed below. In a first example scenario, a mobile compute node 416 (e.g. AMR 102) is moving towards an area where the network QoS cannot be met (e.g. edge of the coverage area where experienced throughput values are reduced). In this example, the network edge devices 430 are configured for real-time reporting of the condition of the network. The network metrics obtained by the system may be used to control (e.g. via the FC 402) to mitigate the workload to reduce the uplink capacity requirement. In another example scenario, the workload running on a compute node may be offloaded to another compute node based on the current battery level and/or battery discharge rate to allow the compute node to operate for a longer period of time before a recharge is required. In another example scenario, where the mobile compute node 116 is moving to an area where the network QoS cannot be met and has a reduced battery level and/or increased battery discharge rate, the network edge devices 430 adjust the wireless beamforming to improve the experienced SNR at the compute node 416 and/or instruct the compute node 416 to adjust the application conditions (e.g. reduce video frame rate, increase the compression ratio) which would provide a less drastic degradation of the performance as opposed to interruption in service.

The flexcells may be applicable in, for example, a smart city where heterogenous compute resources are geographically distributed. The flexcells may be entrusted with formation of flexible cells for a given task. Example tasks may include, search for a stolen vehicle number in a given zip code.” In such a case, compute nodes falling into the zip code may be recruited to form a dynamic cluster to carry out the task of staying alert to the presence of a stolen vehicle. The flexcell concepts may be widely deployed in many smart city applications as would be understood by one of ordinary skill in the art.

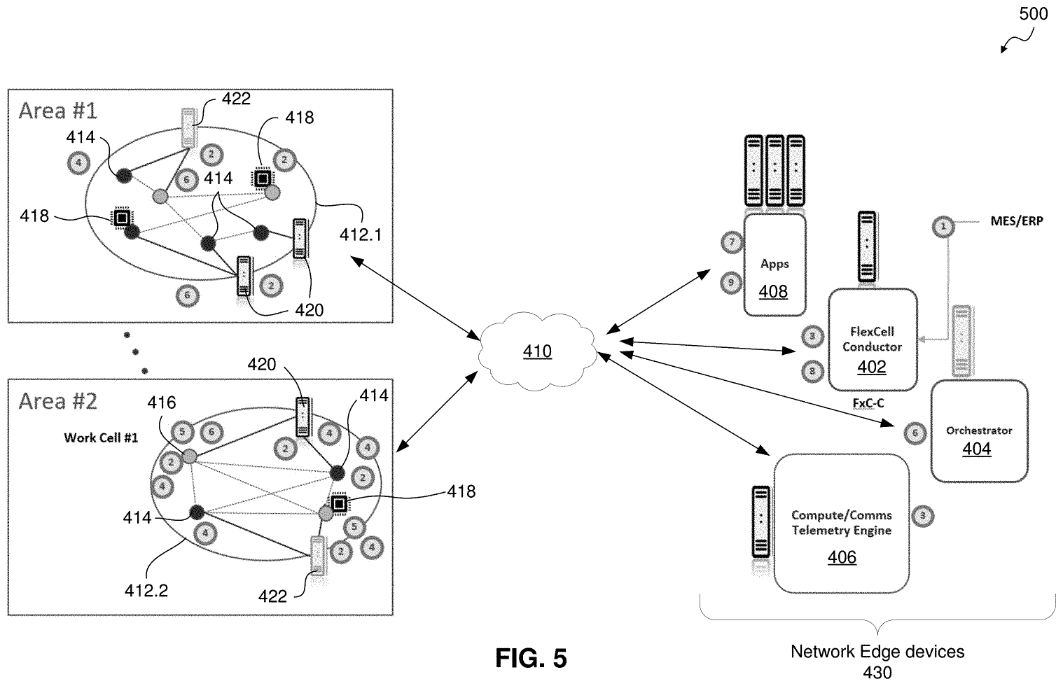

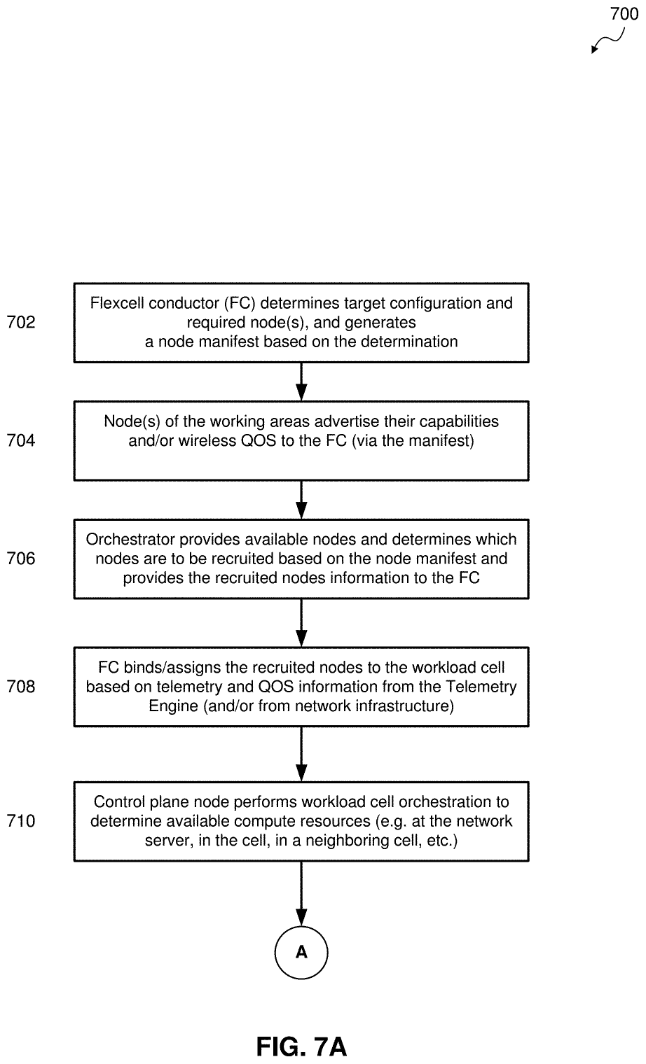

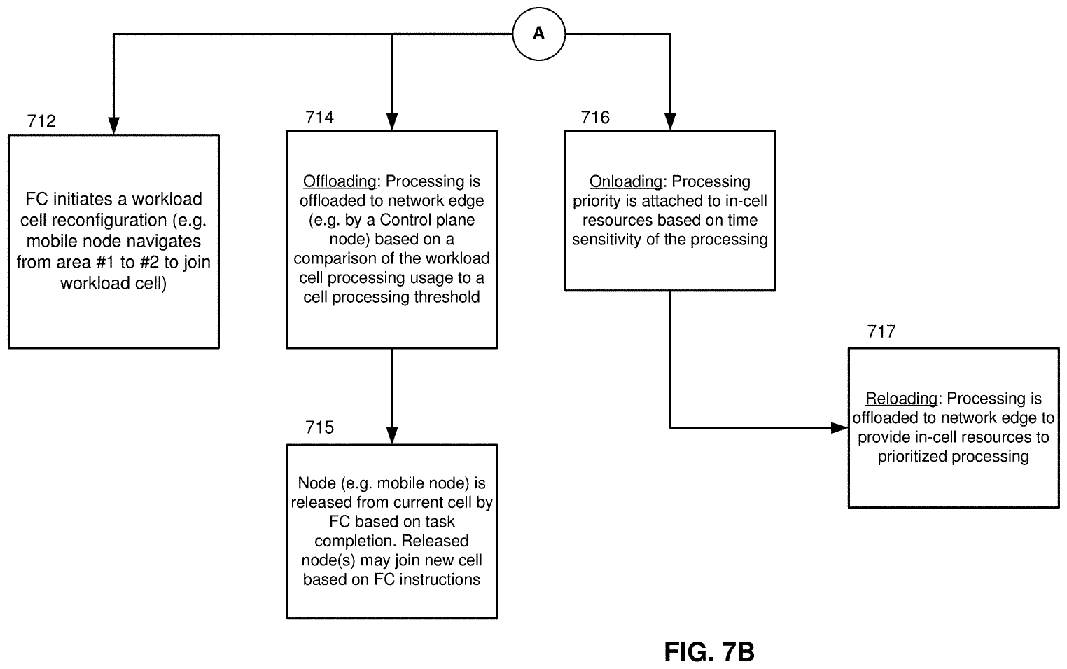

Turning to FIG. 5, an exemplary operation of the system 400 is shown. The system 400 is configured for flexible cluster formation and workload scheduling according to the disclosure. The operation of the system is described with reference to method illustrated in the flowchart 700 of FIGS. 7A-7B. Reference to the operation numbers below corresponds to the numbered circles shown in FIG. 5.

At operation (1), the FC 402 may receive information (e.g. production specifications) and determine a target configuration and required compute nodes for the use case provided in the target configuration. See operation 702 of FIG. 7A.

At operation (2), the compute nodes 414, 416, 418, 420, 422 within the environment 100 may advertise their capabilities (and/or wireless QOS requirements and/or metrics) to the network edge devices 430. The FC 402 may determine a node manifest based on the information received from the compute nodes. The node manifest may include the types and quantity of compute nodes that are needed for a requested task/workload. See operation 704 of FIG. 7A.

At operation (3), the FC 402 communicates with the telemetry engine 406 and the network infrastructure to determine telemetry information and network QoS information. The telemetry information and network QoS information may be used by the FC 402 to facilitate the formation of the workload cells 412. The orchestrator 404 may provide orchestration information to the FC 402 indicating the available compute nodes within the environment 100. The FC 402 may leverage the received orchestration information to determine and manage the workload cell 412 and the deployed compute nodes therein. The orchestration information may include the available compute nodes within the environment 100 and their corresponding attributes. The FC 402 may provide the node manifest to the orchestrator 404, which may be configured to determine the available compute nodes having the necessary attributes identified in the node manifest. The orchestrator 404 may then provide the determined available compute nodes to the FC 402 as the orchestration information. See operation 706 of FIG. 7A.

At operation (4), the FC 402 may establish the workload cell 412. The FC 402 may bind/assign the recruited compute nodes to the workload cell 412 based on telemetry information and/or QoS information received from the Telemetry Engine 406 (and/or from components of the network infrastructure). See operation 708 of FIG. 7A. In the example shown in FIG. 5, Area #2 is selected by the FC 402 to establish the workload cell 412. In establishing the workload cell 412, the FC 402 may control one or more compute nodes to join the workload cell 412. As shown by operation (5), the FC 402 controls the mobile compute node 416 to navigate to Area #2 to join the workload cell 412.2.

Operation (6) illustrates a reloading operation of the FC 402. The FC 402 may release one or more compute nodes when the task assigned the particular compute node has been completed. For example, the FC 402 may release a mobile compute node 416 and the released node is free to navigate the environment and perform one or more predetermined tasks. The FC 402 may control the released node to join another workload cell (e.g. cell 412.1).

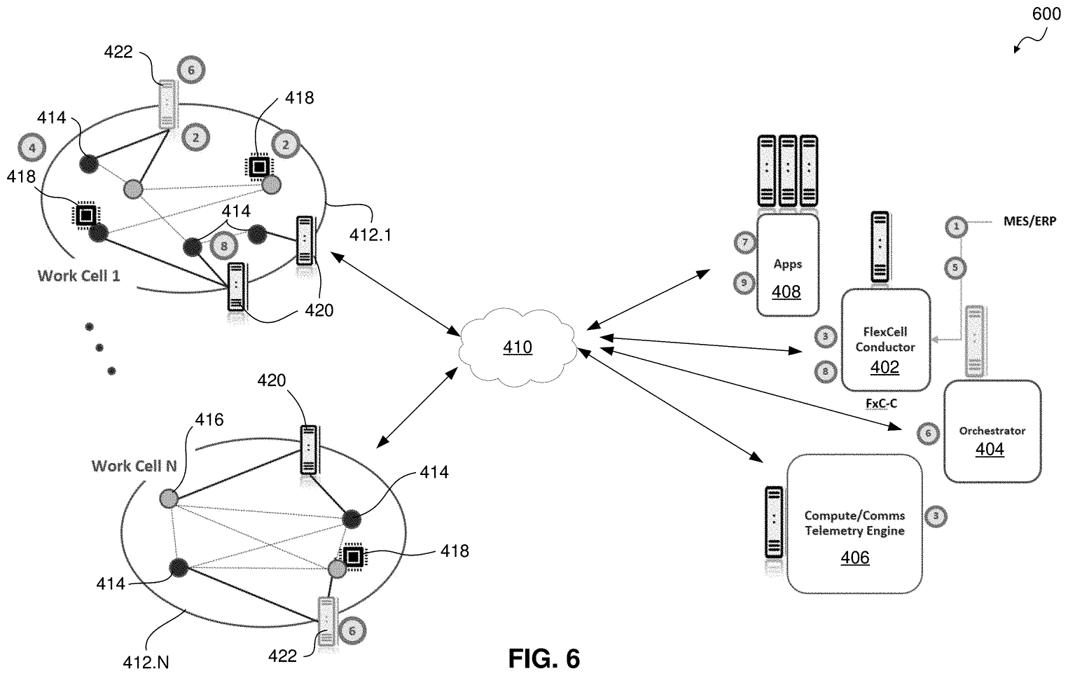

FIG. 6 illustrates another exemplary operation of the system 400. Again, the operation of the system is described with reference to method illustrated in the flowchart 700 of FIGS. 7A-7B.

Operations (1)-(4) are similar to the operations (1)-(4) of FIG. 5, and discussion of these operations has been omitted for brevity. Reference to the operation numbers below corresponds to the numbered circles shown in FIG. 6.

At operation (5), the FC 402 may initiate a workload cell reconfiguration (e.g. mobile node navigates from area #1 to #2 to join workload cell). See operation 712 of FIG. 7B. The reconfiguration may be based on additional or updated information (e.g. production specifications) received by the FC 402.

Operation (6) shows a workload cell orchestration operation. One or more compute nodes (e.g. workload edge control nodes 422) of a workload cell 412 may perform workload cell orchestration at the edge of the workload cell 412. The workload edge control nodes 422 may cooperatively perform the workload cell orchestration operations with the orchestrator 404. See operation 710 of FIG. 7A.

Operation (7) shows an offloading operation at the workload cell 412. In this operation, if the processing usage exceeds a predetermined threshold, the workload (e.g. one or more tasks) may be offloaded to the network edge (e.g. to applications 408) so that the processing resources at the network edge can perform the tasks. The workload edge control nodes 422 and/or the FC 402 may be configured to determine if the processing usage exceeds the threshold and that the workload should be offloaded. See operation 714 of FIG. 7B.

In another offloading operation, a mobile compute node 416 may be released from current workload cell 412 by FC 402 based on the status of the task(s) assigned to the mobile compute node 416. The released node(s) may join a new workload cell 412 based on further instructions from the FC 402. See operation 715 of FIG. 7B.

At operation (8) an onloading operation is shown. In this operation, processing priority for a particular workload task may be attached to in-cell resources based on time sensitivity of the processing. The FC 402 may control the assignment of computing resources within the workload cell 412 for time-critical tasks (e.g. tasks that require low latency). This may include controlling one or more compute nodes to accept and prioritize the workload task. See operation 716 of FIG. 7B.

Operation (9) shows a reloading operation. When one or more workload tasks are loaded into a workload cell 412 as provided in operation (8), the FC 402 may control the offloading of one or more other workload tasks to the network edge to free up processing resources within the workload cell 412 that can be used and assigned to the task(s) loaded on in operation (8). The offloaded task(s) may be offloaded the network edge (e.g. to applications 408) so that the processing resources at the network edge can perform the tasks. See operation 717 of FIG. 7B.

Turning to FIGS. 7A-7B, the method 700 will be discussed in further detail. The method 700 shown may be performed by one or more of the network edge devices 430, such as by the FC 402, orchestrator 404, and/or telemetry engine 406. Two or more of the various operations illustrated in FIGS. 7A-7B may be performed simultaneously in some configurations. Further, the order of the various operations is not limiting and the operations may be performed in a different order in some configurations.

At operation 702, the FC 402 may receive information (e.g. production specifications) and determine a target configuration and required compute nodes for the use case provided in the target configuration.

At operation 704, the compute nodes 414, 416, 418, 420, 422 within the environment 100 may advertise their capabilities (and/or wireless QOS requirements and/or metrics) to the network edge devices 430. The FC 402 may determine a node manifest based on the information received from the compute nodes. The node manifest may include the types and quantity of compute nodes that are needed for a requested task/workload.

At operation 706, the orchestrator 404 may provide orchestration information to the FC 402 indicating the available compute nodes within the environment 100. The FC 402 may leverage the received orchestration information to determine and manage the workload cell 412 and the deployed compute nodes therein. The orchestration information may include the available compute nodes within the environment 100 and their corresponding attributes. The FC 402 may provide the node manifest to the orchestrator 404, which may be configured to determine the available compute nodes having the necessary attributes identified in the node manifest. The orchestrator 404 may then provide the determined available compute nodes to the FC 402 as the orchestration information.

At operation 708, the FC 402 may establish the workload cell 412. The FC 402 may bind/assign the recruited compute nodes to the workload cell 412 based on telemetry information and/or QoS information received from the Telemetry Engine 406 (and/or from components of the network infrastructure).

At operation 710, one or more compute nodes (e.g. workload edge control nodes 422) of a workload cell 412 may perform workload cell orchestration at the edge of the workload cell 412. The workload edge control nodes 422 may cooperatively perform the workload cell orchestration operations with the orchestrator 404.

At operation 712, the FC 402 may initiate a workload cell reconfiguration (e.g. mobile node navigates from area #1 to #2 to join workload cell). The reconfiguration may be based on additional or updated information (e.g. production specifications) received by the FC 402.

At operation 714, an offloading operation may be performed at the workload cell 412. In this operation, if the processing usage exceeds a predetermined threshold, the workload (e.g. one or more tasks) may be offloaded to the network edge (e.g. to applications 408) so that the processing resources at the network edge can perform the tasks. The workload edge control nodes 422 and/or the FC 402 may be configured to determine if the processing usage exceeds the threshold and that the workload should be offloaded.

At operation 715, a mobile compute node 416 may be released from current workload cell 412 by FC 402 based on the status of the task(s) assigned to the mobile compute node 416. The released node(s) may join a new workload cell 412 based on further instructions from the FC 402.

At operation 716, onloading operation may be performed. In this operation, processing priority for a particular workload task may be attached to in-cell resources based on time sensitivity of the processing. The FC 402 may control the assignment of computing resources within the workload cell 412 for time-critical tasks (e.g. tasks that require low latency). This may include controlling one or more compute nodes to accept and prioritize the workload task.

At operation 717, a reloading operation may be performed. When one or more workload tasks are loaded into a workload cell 412, the FC 402 may control the offloading of one or more other workload tasks to the network edge to free up processing resources within the workload cell 412 that can be used and assigned to the loaded task(s). The offloaded task(s) may be offloaded the network edge (e.g. to applications 408) so that the processing resources at the network edge can perform the tasks.

### Examples

The following examples pertain to various techniques of the present disclosure.

An example (e.g. example 1) relates to an apparatus comprising: an orchestrator configured to: determine available compute nodes within an environment; and determine a set of appropriate compute nodes, of the available compute nodes, based on a node manifest; and a flexcell conductor configured to: generate the node manifest based on a target configuration and provide the node manifest to the orchestrator; establish a workload cell based on the target configuration; and populate the established workload cell with the appropriate compute nodes.

Another example (e.g. example 2) relates to a previously-described example (e.g. example 1), wherein the node manifest comprises node types and respective quantities of compute nodes for the workload cell based on the target configuration.

Another example (e.g. example 3) relates to a previously-described example (e.g. example 2), wherein the node types include respective node attributes for the different node types.

Another example (e.g. example 4) relates to a previously-described example (e.g. one or more examples 1-3), wherein the flexcell conductor is further configured to monitor the established workload cell and add one or more other compute nodes to the established workload cell or remove one or more of the appropriate compute nodes from the workload cell.

Another example (e.g. example 5) relates to a previously-described example (e.g. example 4), wherein the flexcell conductor is configured to adjust the node manifest based on the adapted workload cell to reflect changes of the compute nodes within the workload cell.

Another example (e.g. example 6) relates to a previously-described example (e.g. one or more examples 1-5), further comprising a telemetry engine configured to generate telemetry information based on telemetry data received from the compute nodes of the established workload cell, wherein the flexcell conductor is configured to adapt the workload cell based on the telemetry information.

Another example (e.g. example 7) relates to a previously-described example (e.g. example 6), wherein adapting the workload cell comprises adding one or more other compute nodes to the established workload cell or removing one or more of the appropriate compute nodes from the workload cell.

Another example (e.g. example 8) relates to a previously-described example (e.g. one or more examples 6-7), wherein the telemetry information comprises one or more compute-node metrics and/or one or more network metrics.

Another example (e.g. example 9) relates to a previously-described example (e.g. one or more examples 1-8), wherein the orchestrator is configured to determine the appropriate compute nodes further based on telemetry information and/or Quality-of-Service (QoS) information received by the orchestrator.

Another example (e.g. example 10) relates to a previously-described example (e.g. example 9), further comprising a telemetry engine configured to generate the telemetry information based on telemetry data received from the compute nodes.

Another example (e.g. example 11) relates to a previously-described example (e.g. one or more examples 9-10), wherein the telemetry information comprises one or more compute-node metrics and/or one or more network metrics.

Another example (e.g. example 12) relates to a previously-described example (e.g. one or more examples 1-11), wherein the compute nodes comprise one or more autonomous agents.

Another example (e.g. example 13) relates to a previously-described example (e.g. one or more examples 1-12), wherein the flexcell conductor and the orchestrator are embodied in a same computing device.

Another example (e.g. example 14) relates to a previously-described example (e.g. one or more examples 1-12), wherein the flexcell conductor and the orchestrator are embodied in different computing devices.

Another example (e.g. example 15) relates to an apparatus comprising: orchestrating means for: determining available compute nodes within an environment; and determining a set of appropriate compute nodes, of the available compute nodes, based on a node manifest; and conducting means for: generating the node manifest based on a target configuration and provide the node manifest to the orchestrator; establishing a workload cell based on the target configuration; and populating the established workload cell with the appropriate compute nodes.

Another example (e.g. example 16) relates to a previously-described example (e.g. example 15), wherein the node manifest comprises node types and respective quantities of compute nodes for the workload cell based on the target configuration.

Another example (e.g. example 17) relates to a previously-described example (e.g. example 16), wherein the node types include respective node attributes for the different node types.

Another example (e.g. example 18) relates to a previously-described example (e.g. one or more examples 15-17), wherein the conducting means is further configured to monitor the established workload cell and add one or more other compute nodes to the established workload cell or remove one or more of the appropriate compute nodes from the workload cell.

Another example (e.g. example 19) relates to a previously-described example (e.g. example 18), wherein the conducting means is configured to adjust the node manifest based on the adapted workload cell to reflect changes of the compute nodes within the workload cell.

Another example (e.g. example 20) relates to a previously-described example (e.g. one or more examples 15-19), further comprising telemetry means for generating telemetry information based on telemetry data received from the compute nodes of the established workload cell, wherein the conducting means is configured to adapt the workload cell based on the telemetry information.

Another example (e.g. example 21) relates to a previously-described example (e.g. example 20), wherein adapting the workload cell comprises adding one or more other compute nodes to the established workload cell or removing one or more of the appropriate compute nodes from the workload cell.

Another example (e.g. example 22) relates to a previously-described example (e.g. one or more examples 20-21), wherein the telemetry information comprises one or more compute-node metrics and/or one or more network metrics.

Another example (e.g. example 23) relates to a previously-described example (e.g. one or more examples 15-22), wherein the orchestrating means is configured to determine the appropriate compute nodes further based on telemetry information and/or Quality-of-Service (QoS) information received by the orchestrating means.

Another example (e.g. example 24) relates to a previously-described example (e.g. example 23), further comprising telemetry means configured to generate the telemetry information based on telemetry data received from the compute nodes.

Another example (e.g. example 25) relates to a previously-described example (e.g. one or more examples 23-24), wherein the telemetry information comprises one or more compute-node metrics and/or one or more network metrics.

Another example (e.g. example 26) relates to a previously-described example (e.g. one or more examples 15-25), wherein the compute nodes comprise one or more autonomous agents.

Another example (e.g. example 27) relates to a previously-described example (e.g. one or more examples 15-26), wherein the conducting means and the orchestrating means are embodied in a same computing device.

Another example (e.g. example 28) relates to a previously-described example (e.g. one or more examples 15-26), wherein the conducting means and the orchestrating means are embodied in different computing devices.

Another example (e.g. example 29) relates to a non-transitory computer-readable medium having instructions stored thereon that, when executed by processing circuitry of an apparatus, cause the processing circuitry to: determine available compute nodes within an environment; generate a node manifest based on a target configuration; determine a set of appropriate compute nodes, of the available compute nodes, based on the node manifest; establish a workload cell based on the target configuration; and populate the established workload cell with the appropriate compute nodes.

Another example (e.g. example 30) relates to a previously-described example (e.g. example 29), wherein the node manifest comprises node types and respective quantities of compute nodes for the workload cell based on the target configuration.

Another example (e.g. example 31) relates to a previously-described example (e.g. example 30), wherein the node types include respective node attributes for the different node types.

Another example (e.g. example 32) relates to a previously-described example (e.g. one or more examples 29-31), wherein the processing circuitry is further caused to monitor the established workload cell and add one or more other compute nodes to the established workload cell or remove one or more of the appropriate compute nodes from the workload cell.

Another example (e.g. example 33) relates to a previously-described example (e.g. example 32), wherein the processing circuitry is further caused to adjust the node manifest based on the adapted workload cell to reflect changes of the compute nodes within the workload cell.

Another example (e.g. example 34) relates to a previously-described example (e.g. one or more examples 29-33), wherein the processing circuitry is further caused to generate telemetry information based on telemetry data received from the compute nodes of the established workload cell, wherein the workload cell is adapted based on the telemetry information.

Another example (e.g. example 35) relates to a previously-described example (e.g. example 34), wherein adapting the workload cell comprises adding one or more other compute nodes to the established workload cell or removing one or more of the appropriate compute nodes from the workload cell.

Another example (e.g. example 36) relates to a previously-described example (e.g. one or more examples 34-35), wherein the telemetry information comprises one or more compute-node metrics and/or one or more network metrics.

Another example (e.g. example 37) relates to a previously-described example (e.g. one or more examples 29-36), wherein the processing circuitry is further caused to determine the appropriate compute nodes further based on telemetry information and/or Quality-of-Service (QoS) information received by the orchestrator.

Another example (e.g. example 38) relates to a previously-described example (e.g. example 37), wherein the processing circuitry is further caused to generate the telemetry information based on telemetry data received from the compute nodes.

Another example (e.g. example 39) relates to a previously-described example (e.g. one or more examples 37-38), wherein the telemetry information comprises one or more compute-node metrics and/or one or more network metrics.

Another example (e.g. example 40) relates to a previously-described example (e.g. one or more examples 29-39), wherein the compute nodes comprise one or more autonomous agents.

Another example (e.g. example 41) relates to non-transitory computer-readable storage medium with an executable program stored thereon, that when executed, instructs a processor to perform a method as shown and described.

Another example (e.g. example 42) relates to an apparatus as shown and described.

Another example (e.g. example 43) relates a method as shown and described.

### CONCLUSION

The aforementioned description will so fully reveal the general nature of the implementation of the disclosure that others can, by applying knowledge within the skill of the art, readily modify and/or adapt for various applications such specific implementations without undue experimentation and without departing from the general concept of the present disclosure. Therefore, such adaptations and modifications are intended to be within the meaning and range of equivalents of the disclosed implementations, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

Each implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to affect such feature, structure, or characteristic in connection with other implementations whether or not explicitly described.

The exemplary implementations described herein are provided for illustrative purposes, and are not limiting. Other implementations are possible, and modifications may be made to the exemplary implementations. Therefore, the specification is not meant to limit the disclosure. Rather, the scope of the disclosure is defined only in accordance with the following claims and their equivalents.

The designs of the disclosure may be implemented in hardware (e.g., circuits), firmware, software, or any combination thereof. Designs may also be implemented as instructions stored on a machine-readable medium, which may be read and executed by one or more processors. A machine-readable medium may include any mechanism for storing or transmitting information in a form readable by a machine (e.g., a computing device). A machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general-purpose computer.

Throughout the drawings, it should be noted that like reference numbers are used to depict the same or similar elements, features, and structures, unless otherwise noted.

The terms “at least one” and “one or more” may be understood to include a numerical quantity greater than or equal to one (e.g., one, two, three, four, [ . . . ], etc.). The term “a plurality” may be understood to include a numerical quantity greater than or equal to two (e.g., two, three, four, five, [ . . . ], etc.).

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. The terms “group (of)”, “set (of)”, “collection (of)”, “series (of)”, “sequence (of)”, “grouping (of)”, etc., and the like in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The phrase “at least one of” with regard to a group of elements may be used herein to mean at least one element from the group consisting of the elements. The phrase “at least one of” with regard to a group of elements may be used herein to mean a selection of: one of the listed elements, a plurality of one of the listed elements, a plurality of individual listed elements, or a plurality of a multiple of individual listed elements.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned data types and may take various forms and represent any information as understood in the art.

The terms “processor,” “processing circuitry,” or “controller” as used herein may be understood as any kind of technological entity that allows handling of data. The data may be handled according to one or more specific functions executed by the processor, processing circuitry, or controller. Further, processing circuitry, a processor, or a controller as used herein may be understood as any kind of circuit, e.g., any kind of analog or digital circuit. Processing circuitry, a processor, or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as processing circuitry, a processor, controller, or logic circuit. It is understood that any two (or more) of the processors, controllers, logic circuits, or processing circuitries detailed herein may be realized as a single entity with equivalent functionality or the like, and conversely that any single processor, controller, logic circuit, or processing circuitry detailed herein may be realized as two (or more) separate entities with equivalent functionality or the like.

As used herein, “memory” is understood as a computer-readable medium in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, among others, or any combination thereof. Registers, shift registers, processor registers, data buffers, among others, are also embraced herein by the term memory. The term “software” refers to any type of executable instruction, including firmware.

In one or more of the implementations described herein, processing circuitry can include memory that stores data and/or instructions. The memory can be any well-known volatile and/or non-volatile memory, including read-only memory (ROM), random access memory (RAM), flash memory, a magnetic storage media, an optical disc, erasable programmable read only memory (EPROM), and programmable read only memory (PROM). The memory can be non-removable, removable, or a combination of both.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). Processing circuitry, a processor, or a controller may transmit or receive data over a software-level connection with another processor, controller, or processing circuitry in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both ‘direct’ calculations via a mathematical expression/formula/relationship and ‘indirect’ calculations via lookup or hash tables and other array indexing or searching operations.

An “agent” may be understood to include any type of driven object. An agent may be a driven object with a combustion engine, a reaction engine, an electrically driven object, a hybrid driven object, or a combination thereof. An agent may be or may include a moving robot, a personal transporter, a drone, and the like.

The term “autonomous agent” may describe an agent that implements all or substantially all navigational changes, at least during some (significant) part (spatial or temporal, e.g., in certain areas, or when ambient conditions are fair, or on highways, or above or below a certain speed) of some drives. Sometimes an “autonomous agent” is distinguished from a “partially autonomous agent” or a “semi-autonomous agent” to indicate that the agent is capable of implementing some (but not all) navigational changes, possibly at certain times, under certain conditions, or in certain areas. A navigational change may describe or include a change in one or more of steering, braking, or acceleration/deceleration of the agent. An agent may be described as autonomous even in case the agent is not fully automatic (fully operational with driver or without driver input). Autonomous agents may include those agents that can operate under driver control during certain time periods and without driver control during other time periods. Autonomous agents may also include agents that control only some implementations of agent navigation, such as steering (e.g., to maintain an agent course between agent lane constraints) or some steering operations under certain circumstances (but not under all circumstances), but may leave other implementations of agent navigation to the driver (e.g., braking or braking under certain circumstances). Autonomous agents may also include agents that share the control of one or more implementations of agent navigation under certain circumstances (e.g., hands-on, such as responsive to a driver input) and agents that control one or more implementations of agent navigation under certain circumstances (e.g., hands-off, such as independent of driver input). Autonomous agents may also include agents that control one or more implementations of agent navigation under certain circumstances, such as under certain environmental conditions (e.g., spatial areas, roadway conditions). In some implementations, autonomous agents may handle some or all implementations of braking, speed control, velocity control, and/or steering of the agent. An autonomous agent may include those agents that can operate without a driver. The level of autonomy of an agent may be described or determined by the Society of Automotive Engineers (SAE) level of the agent (as defined by the SAE in SAE J3016 2018: Taxonomy and definitions for terms related to driving automation systems for on road motor vehicles) or by other relevant professional organizations. The SAE level may have a value ranging from a minimum level, e.g. level 0 (illustratively, substantially no driving automation), to a maximum level, e.g. level 5 (illustratively, full driving automation).

The systems and methods of the disclosure may utilize one or more machine learning models to perform corresponding functions of the agent (or other functions described herein). The term “model” as, for example, used herein may be understood as any kind of algorithm, which provides output data from input data (e.g., any kind of algorithm generating or calculating output data from input data). A machine learning model may be executed by a computing system to progressively improve performance of a specific task. According to the disclosure, parameters of a machine learning model may be adjusted during a training phase based on training data. A trained machine learning model may then be used during an inference phase to make predictions or decisions based on input data.

The machine learning models described herein may take any suitable form or utilize any suitable techniques. For example, any of the machine learning models may utilize supervised learning, semi-supervised learning, unsupervised learning, or reinforcement learning techniques.

In supervised learning, the model may be built using a training set of data that contains both the inputs and corresponding desired outputs. Each training instance may include one or more inputs and a desired output. Training may include iterating through training instances and using an objective function to teach the model to predict the output for new inputs. In semi-supervised learning, a portion of the inputs in the training set may be missing the desired outputs.

In unsupervised learning, the model may be built from a set of data which contains only inputs and no desired outputs. The unsupervised model may be used to find structure in the data (e.g., grouping or clustering of data points) by discovering patterns in the data. Techniques that may be implemented in an unsupervised learning model include, e.g., self-organizing maps, nearest-neighbor mapping, k-means clustering, and singular value decomposition.

Reinforcement learning models may be given positive or negative feedback to improve accuracy. A reinforcement learning model may attempt to maximize one or more objectives/rewards. Techniques that may be implemented in a reinforcement learning model may include, e.g., Q-learning, temporal difference (TD), and deep adversarial networks.

The systems and methods of the disclosure may utilize one or more classification models. In a classification model, the outputs may be restricted to a limited set of values (e.g., one or more classes). The classification model may output a class for an input set of one or more input values. An input set may include road condition data, event data, sensor data, such as image data, radar data, LIDAR data and the like, and/or other data as would be understood by one of ordinary skill in the art. A classification model as described herein may, for example, classify certain driving conditions and/or environmental conditions, such as weather conditions, road conditions, and the like. References herein to classification models may contemplate a model that implements, e.g., any one or more of the following techniques: linear classifiers (e.g., logistic regression or naive Bayes classifier), support vector machines, decision trees, boosted trees, random forest, neural networks, or nearest neighbor.

One or more regression models may be used. A regression model may output a numerical value from a continuous range based on an input set of one or more values. References herein to regression models may contemplate a model that implements, e.g., any one or more of the following techniques (or other suitable techniques): linear regression, decision trees, random forest, or neural networks.

A machine learning model described herein may be or may include a neural network. The neural network may be any kind of neural network, such as a convolutional neural network, an autoencoder network, a variational autoencoder network, a sparse autoencoder network, a recurrent neural network, a deconvolutional network, a generative adversarial network, a forward-thinking neural network, a sum-product neural network, and the like. The neural network may include any number of layers. The training of the neural network (e.g., adapting the layers of the neural network) may use or may be based on any kind of training principle, such as backpropagation (e.g., using the backpropagation algorithm).

As described herein, the following terms may be used as synonyms: driving parameter set, driving model parameter set, safety layer parameter set, driver assistance, automated driving model parameter set, and/or the like (e.g., driving safety parameter set). These terms may correspond to groups of values used to implement one or more models for directing an agent to operate according to the manners described herein. Furthermore, throughout the present disclosure, the following terms may be used as synonyms: driving parameter, driving model parameter, safety layer parameter, driver assistance and/or automated driving model parameter, and/or the like (e.g., driving safety parameter), and may correspond to specific values within the previously described sets.

1. An apparatus comprising:
an orchestrator configured to:
determine available compute nodes within an environment; and
determine a set of appropriate compute nodes, of the available compute nodes, based on a node manifest; and
a flexcell conductor configured to:
generate the node manifest based on a target configuration and provide the node manifest to the orchestrator;
establish a workload cell based on the target configuration; and
populate the established workload cell with the appropriate compute nodes.

2. The apparatus of claim 1, wherein the node manifest comprises node types and respective quantities of compute nodes for the workload cell based on the target configuration.

3. The apparatus of claim 2, wherein the node types include respective node attributes for the different node types.

4. The apparatus of claim 1, wherein the flexcell conductor is further configured to monitor the established workload cell and add one or more other compute nodes to the established workload cell or remove one or more of the appropriate compute nodes from the workload cell.

5. The apparatus of claim 4, wherein the flexcell conductor is configured to adjust the node manifest based on the adapted workload cell to reflect changes of the compute nodes within the workload cell.

6. The apparatus of claim 1, further comprising a telemetry engine configured to generate telemetry information based on telemetry data received from the compute nodes of the established workload cell, wherein the flexcell conductor is configured to adapt the workload cell based on the telemetry information.

7. The apparatus of claim 6, wherein adapting the workload cell comprises adding one or more other compute nodes to the established workload cell or removing one or more of the appropriate compute nodes from the workload cell.

8. The apparatus of claim 6, wherein the telemetry information comprises one or more compute-node metrics and/or one or more network metrics.

9. The apparatus of claim 1, wherein the orchestrator is configured to determine the appropriate compute nodes further based on telemetry information and/or Quality-of-Service (QoS) information received by the orchestrator.

10. The apparatus of claim 9, further comprising a telemetry engine configured to generate the telemetry information based on telemetry data received from the compute nodes.

11. The apparatus of claim 9, wherein the telemetry information comprises one or more compute-node metrics and/or one or more network metrics.

12. The apparatus of claim 1, wherein the compute nodes comprise one or more autonomous agents.

13. The apparatus of claim 1, wherein the flexcell conductor and the orchestrator are embodied in a same computing device.

14. The apparatus of claim 1, wherein the flexcell conductor and the orchestrator are embodied in different computing devices.

15. An apparatus comprising:
orchestrating means for:
determining available compute nodes within an environment; and
determining a set of appropriate compute nodes, of the available compute nodes, based on a node manifest; and
conducting means for:
generating the node manifest based on a target configuration and provide the node manifest to the orchestrator;
establishing a workload cell based on the target configuration; and
populating the established workload cell with the appropriate compute nodes.

16. The apparatus of claim 15, wherein the node manifest comprises node types and respective quantities of compute nodes for the workload cell based on the target configuration.

17. The apparatus of claim 16, wherein the node types include respective node attributes for the different node types.

18. The apparatus of claim 15, wherein the conducting means is further configured to monitor the established workload cell and add one or more other compute nodes to the established workload cell or remove one or more of the appropriate compute nodes from the workload cell.

19. The apparatus of claim 15, further comprising telemetry means for generating telemetry information based on telemetry data received from the compute nodes of the established workload cell, wherein the conducting means is configured to adapt the workload cell based on the telemetry information.

20. A non-transitory computer-readable medium having instructions stored thereon that, when executed by processing circuitry of an apparatus, cause the processing circuitry to:
determine available compute nodes within an environment;
generate a node manifest based on a target configuration;
determine a set of appropriate compute nodes, of the available compute nodes, based on the node manifest;
establish a workload cell based on the target configuration; and
populate the established workload cell with the appropriate compute nodes.

21. The non-transitory computer-readable storage medium of claim 20, wherein the node manifest comprises node types and respective quantities of compute nodes for the workload cell based on the target configuration.

22. The non-transitory computer-readable storage medium of claim 21, wherein the node types include respective node attributes for the different node types.

23. The non-transitory computer-readable storage medium of claim 20, wherein the processing circuitry is further caused to monitor the established workload cell and add one or more other compute nodes to the established workload cell or remove one or more of the appropriate compute nodes from the workload cell.

24. The non-transitory computer-readable storage medium of claim 20, wherein the processing circuitry is further caused to generate telemetry information based on telemetry data received from the compute nodes of the established workload cell, wherein the workload cell is adapted based on the telemetry information.

25. The non-transitory computer-readable storage medium of claim 24, wherein the telemetry information comprises one or more compute-node metrics and/or one or more network metrics.
